(19) United States
(12) Patent Application Publication
(10) Pub. No.: US 2008/0015887 A1
(43) Pub. Date: Jan. 17, 2008

(54) System and process for enrollment and sales

(75) Inventors: Timothy Allen Drabek, McKinney, TX (US); Jon Christopher Coley, Rowlett, TX (US); James Robert Frizzell, Plano, TX (US); Joe Angel Perez, McKinney, TX (US)

Correspondence Address: WILEY REIN LLP, 1776 K. STREET N.W., WASHINGTON, DC, 20006, US

(73) Assignee: AEGON DIRECT MARKETING SERVICES, INC.

(21) Appl. No.: 11/812,956

(22) Filed: Jun. 22, 2007

Related U.S. Application Data
(60) Provisional application No. 60/830,676, filed on Jul. 14, 2006.

(51) Int. Cl. G06Q 30/00

(52) U.S. Cl. 705/1

(57) ABSTRACT

An automated process for providing sales services includes establishing communications between a customer and a first representative, alerting the first representative to a product for which the customer is eligible, transmitting a lead record for the customer to a second representative upon determining that the customer is interested in a product, establishing communications between the customer and the second representative, completing a sales record for the customer, generating a menu of products from which the customer may select, selecting a product from the menu of products, and completing a sale of the selected product. Typically, products to be offered will be identified, and a customer database will be segmented to match the offered products with eligible customers. The sale of the selected product will typically be completed by establishing communications between the customer and a representative authorized to sell the selected product to the customer.

### CROSS-REFERENCE TO RELATED APPLICATIONS

This application claims the benefit of U.S. provisional application No. 60/830,676, filed 14 Jul. 2006, which is hereby incorporated by reference as though fully set forth herein.

### BACKGROUND OF THE INVENTION

a. Field of the Invention

The instant invention relates to product sales. More specifically, the instant invention relates to a system and method for automating sales, particularly of insurance products.

b. Background Art

Insurance is a highly-regulated industry, with sales of insurance being subject to an extensive regulatory regime that varies from state to state and product to product. Thus, to sell an insurance product to a customer, it is necessary to determine first whether the customer is eligible for the product and second whether the representative with whom the customer is dealing is licensed by the customer's state of residence to sell the product to the customer.

It is known, therefore, for an insurance customer to initiate an insurance purchase by contacting a first representative. The first representative collects initial information from the customer. Once the information is collected, the communication session between the customer and the first representative is typically terminated. At a later time, a second representative, who is preferably licensed by the customer's state of residence to sell the product in which the customer is interested, follows up with the customer to complete the transaction. In this process, it may be necessary for the second representative to ask the customer to provide information that the customer already furnished to the first representative.

In addition, non-insurance businesses, such as banks and other financial institutions, often have customer bases that are also potential customers for insurance companies. The non-insurance businesses, however, typically do not employ representatives that are licensed to sell insurance products.

### BRIEF SUMMARY OF THE INVENTION

It is therefore desirable to be able to complete a sale of an insurance product in a reduced amount of time, for example a single telephone call.

It is also desirable to be able to leverage the customer base of the non-insurance business for insurance sales.

It is also desirable to be able to capture customer data once and then share that data amongst representatives or between companies during the course of a transaction.

Disclosed herein is an automated process for providing sales services. The process includes the following steps: establishing a communication connection between a customer and a first representative using a switching network; providing a plurality of prompts to the first representative who will then ask questions of the customer to obtain a first plurality of customer data sets; storing the first plurality of customer data sets into a database, the first plurality of customer data sets including at least identification information, residence information, and a desired product; identifying a second representative based in part on the residence information and the desired product; establishing a communication connection between at least the customer and the second representative without disconnecting the customer from the switching network; providing a plurality of prompts to the second representative who will then ask questions of the customer to obtain a second plurality of customer data sets, wherein the second plurality of customer data sets include at least some information that is not included in the first plurality of data sets; storing the second plurality of customer data sets into a database; and completing a sale between the second representative and the customer before disconnecting the customer from the switching network.

The first representative or the second representative may be granted access to the database based on a validation of user identification information and a password. A database containing licensing information for a plurality of representatives may be accessed to grant the second representative access to the customer based on a validation of user identification information, a password, and a verification that the second representative is licensed to sell the desired product within the state that the customer resides. The second representative may also be given access to the first plurality of customer data sets.

Typically, the communication session between at least the customer and the second representative will utilize a telephone system. For example, a telephone system may be used to create a conference between the first representative, the second representative, and the customer. The first representative may, if desired, be disconnected.

In some embodiments of the invention, the sale is completed by verifying that the customer is interested in purchasing the desired product, providing the customer with pricing information for the desired product, and obtaining payment instructions from the customer who is paying for the desired product. Optionally, the payment instructions may be recorded, for example as by recording a conversation in which the customer authorizes payment and associating the recording with a database entry. Alternatively, the recording may be accomplished by capturing data indicative of the customer's authorization of a payment, for example capture of an electronic signature.

In another aspect of the present invention, an automated process for providing sales services includes: establishing a communication connection between a customer and a switching network; presenting a first plurality of questions to the customer to obtain a first plurality of customer data sets including at least identification information, state of residence, and a desired product; storing the first plurality of customer data sets into a common database; identifying a second representative based in part on the residence information and the desired product, including verifying that the second representative is licensed to sell the desired product for the customer's state of residence; establishing a communication connection between at least the customer and the second representative without disconnecting the customer from the switching network; giving the second representative access to the first plurality of customer data sets; storing the second plurality of customer data sets into the common database; and completing a sale between the second representative and the customer before disconnecting the customer from the switching network.

The communication connection between the customer and the switching network will typically be established by establishing a connection between the customer and the switching network; identifying first representative who is available to communicate with the customer; and establishing a communication connection between the customer and the first representative without disconnecting the customer from the switching network. In some embodiments of the invention, a first plurality of prompts will be presented to the first representative, and the first representative will in turn ask a first plurality of questions of the customer to obtain a first plurality of customer responses, which may then be entered to create a first plurality of customer data sets.

Also disclosed herein is a system for assisting in the provision of services. The system includes: a switching network that supports communication connections; a customer interface that accepts inquiries from a customer; a first representative interface that permits a first registered user to access the switching network and to communicate with the customer; a first input interface to permit the first registered user to input a first plurality of customer data sets including at least identification information, state of residence, and a desired product; a first database to store the first plurality of customer data sets; a second representative interface that permits a second registered user to access the switching network and the database, and to communicate with the customer, wherein the interface permits access based on the residence information, the desired product, and a confirmation that the second registered user is licensed to sell the desired product for the customer's state of residence, and wherein the second representative interface establishes a communication connection between the customer and the second registered user without disconnecting the customer from the switching network; a second input interface to permit the second registered user to input a second plurality of customer data sets, including information not included in the first plurality of customer data sets; and a second database to store the second plurality of customer data sets.

In some embodiments of the invention, the first and second databases are common to each other. An optional recorder or recording system may be used to record confirmation information to acknowledge the customer has requested to purchase the desired product. In addition, a transaction system may be provided to complete a sale of the desired product to the customer.

In other embodiments, a system for assisting in the provision of services includes: a switching network that supports communication connections; a customer interface that accepts inquiries from a customer; a first input menu to create a first plurality of customer data sets including at least identification information, state of residence, and a desired product; a database to store the first plurality of customer data sets; and a representative interface that permits a registered user to access the database based on the residence information, the desired product, and a confirmation that the registered user is licensed to sell the desired product for the customer's state of residence, and wherein the representative interface permits the establishment of a communication connection between the customer and the registered user in real time such that the registered user may complete a sale. Preferably, the transaction may be completed within less than about fifteen minutes from when the first plurality of customer data sets was input.

In still another aspect of the invention, an automated process for providing sales services includes the following steps: establishing a communication connection between a customer and a first representative using a switching network; providing a plurality of prompts to the first representative who then asks questions of the customer to obtain a first plurality of customer data sets; storing the first plurality of customer data sets, including at least identification information, residence information, and a desired product, into a first database; automatically identifying a second representative in response to the residence information and the desired product; automatically establishing a communication connection between at least the customer and the second representative without disconnecting the customer from the switching network; providing a plurality of prompts to the second representative who then asks questions of the customer to obtain a second plurality of customer data sets including at least some information that is not included in the first plurality of customer data sets; and storing the second plurality of customer data sets into a second database.

According to yet another aspect of the invention, an automated process for providing sales services includes: establishing a communication session between a customer and a first representative; alerting the first representative to at least one product for which the customer is eligible; transmitting at least identification data regarding the customer to a second representative upon determining that the customer is interested in purchasing the at least one product for which the customer is eligible; establishing a communication session between the customer and the second representative; completing a sales record for the customer, the sales record including at least the identification data transmitted to the second representative; generating a menu of products from which the customer may select based at least in part upon the sales record; selecting a product from the menu of products; and completing a sale of the selected product. The process may also include identifying one or more products to be offered and segmenting a customer database to match the one or more offered products with customers within the customer database who are eligible for the one or more offered products. In such embodiments, the representative may be alerted based upon information in the segmented customer database.

At least identification data regarding the customer may be transmitted to the second representative in the form of a lead record. The lead record may be stored to a database of lead records, and the second representative may be granted access thereto. The lead record may be presented to the second representative thereafter.

The sales record may be pre-populated with at least the identification data regarding the customer transmitted to the second representative, and this information may be verified with the customer. Optionally, the sales record may be augmented with at least one additional item of data regarding the customer, such as the customer's state of residence, that is gathered by the second representative.

The menu of products from which the customer may select may be generated by accessing a database of products and identifying, based at least in part upon the sales record, one or more products within the database for which the customer is eligible. The identified products may then be complied into the menu.

The sale of the selected product will typically be completed by establishing a communication session between the customer and a representative authorized to sell the selected product to the customer, providing the authorized representative with the sales record for the customer and information concerning the selected product, and having the authorized representative complete the sale. In some embodiments of the invention, the sales record, including the information concerning the selected product, is stored to a database of pending sales records. The authorized representative may be granted to access to the database of pending sales records, and the pending sales record may then be presented to the authorized representative. It is contemplated that the authorized representative may be neither the first nor the second representative, and may be identified by analyzing one or more of the selected product and the customer's state of residence.

Preferably, the communication session between the customer and the second representative is established without terminating the communication session between the customer and the first representative. For example, the first representative may use a telephone network to “warm-transfer” (that is, transfer without hanging up) the customer to the second representative.

Upon selecting a product from the menu of products, one or more items of additionally required information may be determined and collected. In some embodiments, the determination and collection process is a dynamic process (that is, the collection of certain items of additionally required information may cause the determination of further items of additionally required information, and so on).

In a further embodiment of the invention, an automated process for product sales includes: establishing a communication session between a customer and a computer system, wherein the computer system is provided with access to a database of products that may be offered for sale to the customer; collecting a plurality of data from the customer, including at least data identifying the customer and a state of residence of the customer; identifying at least one product within the database of products for which the customer is eligible based, at least in part, upon the state of residence of the customer; selecting one of the identified products for purchase; establishing a communication session between the customer and a representative authorized to sell the selected product; and having the representative authorized to sell the selected product complete a sale of the selected product. Typically, the communication session between the customer and the computer system is mediated by at least one representative, who may be connected over a telephone network. It is also contemplated, however, that the communication session between the customer and the computer system may occur through an integrated voice response (IVR) system. Preferably, the data is collected by entering the plurality of data via a web-based user interface.

The present invention also provides an automated process for generating sales leads. The process includes the following steps: selecting one or more products provided by a first company to be offered to customers of a second company; updating customer records within a customer database of the second company to include information regarding those of the selected one or more products for which each customer is eligible; notifying a customer of the second company that the customer is eligible for a product provided by the first company; ascertaining the customer's level of interest in the product provided by the first company for which the customer is eligible; and creating a lead record including at least information identifying the customer, the product for which the customer is eligible, and the customer's level of interest in the product. The lead record may then be transmitted to the first company. In some embodiments of the invention, a real-time communication session is established between the customer and the second company (e.g., between the customer and a representative of the second company), and the customer is notified of the customer's eligibility during the real-time communication session.

Also disclosed is an automated sales system, including: a communication network; a customer database; a first representative interface that permits a first registered user to access the communication network and the customer database; a notification processor to retrieve from the customer database a customer record for a customer connected to the communication network, wherein the customer record includes identification information for the customer and information regarding one or more products for which the customer is eligible, and wherein the notification processor generates a notification to the first representative that the customer is eligible for one or more products; a lead record database to store a plurality of lead records; and a lead processor to generate a lead record and store the lead record to the lead record database, wherein the lead record is generated when the customer connected to the communication network indicates interest in one or more products for which the customer is eligible, and wherein the lead record includes at least the identification information for the customer.

An advantage of the invention is that permits the completion of sales and enrollments in a reduced amount of time.

Another advantage of the invention is that provides real-time licensure checks, eligibility determinations, enrollments, and sales.

Still another advantage of the present invention is that it permits transactions to be completed during a single communication session.

Yet another advantage of the present invention is that it permits non-insurance companies to determine eligibility for and offer to customers a highly-regulated product without themselves assuming the burden of regulation.

A further advantage of the present invention is that it permits insurance companies to utilize outside companies to pre-screen customers for eligibility, which reduces the administrative burden on the insurance company to collect customer information prior to completing the sale.

Yet a further advantage of the present invention is that it seamlessly transfers customer data between business call centers such that the customer does not need to provide the same information repeatedly.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a flowchart of a lead generation process.

FIG. 2 is a flowchart illustrating steps that may be executed in generating a sales record.

FIG. 3 is a block diagram of an exemplary system according to an embodiment of the present invention.

FIG. 4 illustrates a log-on screen for representatives.

FIG. 5 depicts a plurality of lead records.

FIG. 6 shows an individual lead record, such as might be selected from the plurality of lead records depicted in FIG. 5.

FIG. 7 is an exemplary sales record illustrating a menu of products from which the customer may select.

FIG. 8 illustrates the sales record of FIG. 7 after a product has been selected from the menu where a non-agent representative is viewing the sales record.

FIG. 9 illustrates the sales record of FIG. 7 after a product has been selected from the menu where an agent is viewing the sales record.

FIG. 10 illustrates a plurality of pending enrollment records.

FIG. 11 shows an individual pending enrollment record, such as might be selected from the plurality of pending enrollment records depicted in FIG. 10.

### DETAILED DESCRIPTION OF THE INVENTION

The present invention provides a system and method for real-time solicitation, eligibility assessment, and enrollment processing for a business partner's customer in a seller's products. For purposes of this disclosure, the term “product” encompasses both goods and services. The terms “seller” and “business partner,” as used herein, refer to separate business entities that cooperate in offering products to customers as described herein.

The present invention will be described in the context of insurance sales, where the seller is an insurance company, and the business partner is a financial institution that offers the insurance company's products to customers of the financial institution. It is contemplated, however, that the invention may be practiced in the sale of other products, as would be appreciated by one of ordinary skill in the art. To simplify explanation of the invention, the description below will refer to the financial institution business partner as “Company A” and the insurance company seller as “Company B.”

Company A will typically have a call center in which customers of Company A are serviced or sold Company A's products (e.g., auto loans, home loans, and credit cards). Company A and Company B will typically cooperate to identify which of Company B's products (e.g., term life insurance policies, health insurance policies, accidental death and dismemberment insurance policies) will be offered to customers of Company A, typically based upon profitability and suitability to Company A's customer base. Company B will then provide Company A with any regulatory and/or marketing requirements associated with the identified products. These requirements, which may be referred to collectively as “eligibility criteria,” are specific to the identified Company B products, and are typically based on the customer's state of residence, age, and gender, but may also relate to other customer attributes, including, without limitation, mortgage amount, ZIP code, and income.

Once Company A receives the eligibility criteria from Company B, Company A can apply the eligibility criteria to its customer database. This process, referred to herein as “segmenting” the Company A customer database, matches the identified Company B products with Company A customers who are eligible to purchase the identified Company B products. For example, if an identified Company B annuity is available only to males between the ages of 25 and 34, the Company A customer database will be updated such that all records for males between the ages of 25 and 34 indicate eligibility for this particular Company B annuity. Company A is thus provided the tools and information necessary to determine if a particular Company A customer is eligible for Company B products, to include regulated products. The present invention also contemplates real-time updates to the eligibility criteria, and also to the Company A customer database, which will facilitate insurance compliance by helping to prevent a product from being inadvertently issued to an ineligible customer.

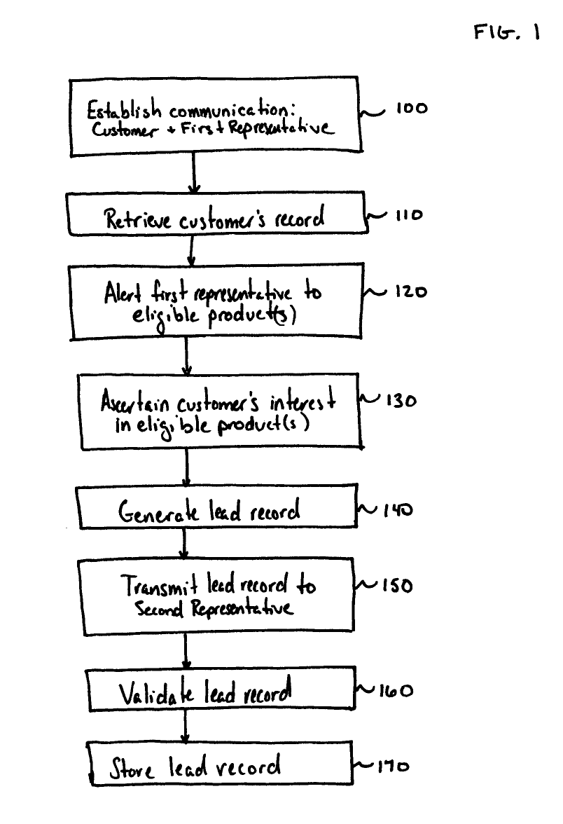

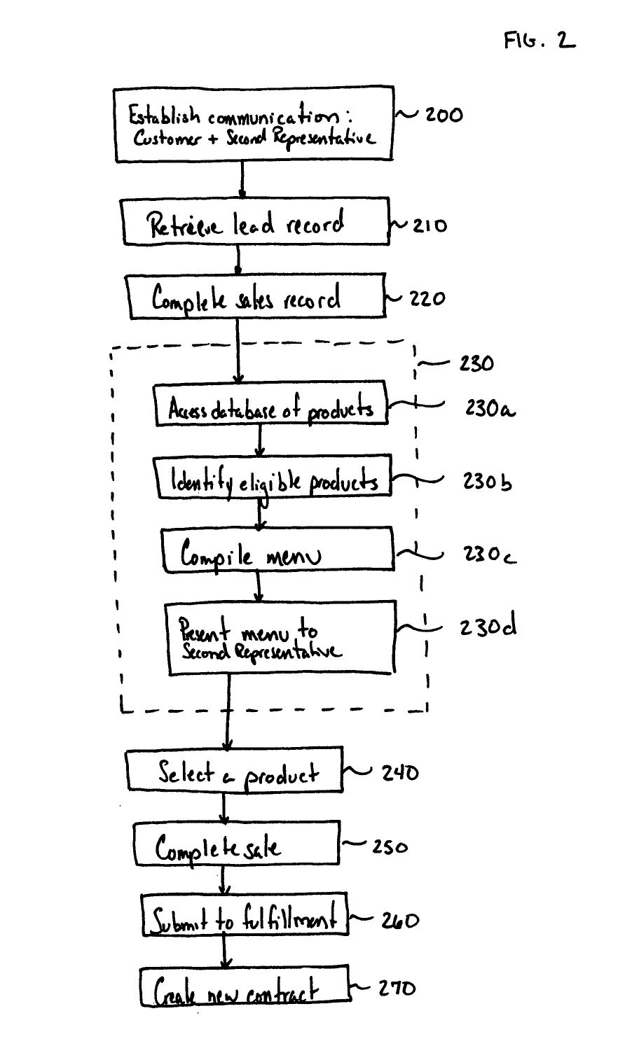

An embodiment of a method and system for automated sales will now be described with reference to the flowcharts of FIGS. 1 and 2. The first part of the process, lead generation, is illustrated in FIG. 1. In block 100, a communication session is established between a customer of Company A and a first representative, who is preferably a representative at Company A's call center. Of course, as will be understood by one of ordinary skill, the representative at Company A's call center may be either an independent contractor or an employee of Company A, and may be connected to the communication network from any location.

Typically, the communication session between the customer and the first representative will be established over a telephone network, for example when the customer calls the Company A call center for assistance with a Company A product (e.g., the customer wishes to inquire about the customer's home mortgage loan with Company A). It is contemplated, however, that the invention may also be practiced over other communication networks. For example, the customer and the first representative may be connected over a computer network (e.g., the Internet) via an instant messaging program, a chat program, or a voice over Internet protocol (VOIP) connection.

The identity of the customer will typically be established and verified during initiation of the communication session between the customer and the first representative. For example, the customer may be asked to enter an account number or other identifier using the customer's telephone keypad prior to being connected to the first representative, who may then follow up with additional security questions to verify the identity of the customer. Alternatively, the customer may be immediately connected to the first representative, who may ask the customer for one or more pieces of information (e.g., name, date of birth, and mother's maiden name) to establish and verify the identity of the customer. The first representative may input this information into Company A's computer system via any suitable interface, such as a web-based form.

Based upon the identifying information furnished during the establishment of the communication session, the customer's record may be retrieved from the Company A customer database in step 110 in order for the first representative to assist the customer with the customer's request of Company A. As described above, the Company A customer database is segmented to include information regarding those Company B products, if any, for which the customer is eligible. Accordingly, if the customer's record in the Company A customer database indicates eligibility for any Company B products offered by Company A, the first representative is alerted to this in step 120, for example by presenting an appropriate dialog box to the first representative. The dialog box may include a suggested narrative that the first representative may use to inform the customer that the customer is eligible for a Company B product. In step 130, the first representative ascertains the customer's interest in the Company B products for which the customer is eligible (e.g., not interested, interested in further information, interested in purchasing).

Assuming that the customer is interested in one of the Company B products for which the customer is eligible, the first representative may initiate generation of a lead record in step 140. Once completed, the lead record may be transmitted to a second representative, who will typically be an employee of Company B, in step 150. It is contemplated that the lead record may include only identification data regarding the customer. Preferably, however, the lead record includes additional information, including, but not limited to, the customer's name, address, city, state, ZIP code, date of birth, phone number, and gender. Any or all of this information may be pre-populated from the customer's record in Company A's customer database. In addition, the first representative may solicit from the customer, and input via a suitable interface, such as a web-based form, additional data to generate the lead record. For example, the system may provide the first representative with a series of question prompts, and the first representative may ask the questions of the customer and input the answers to the system (e.g., by typing input into text boxes, by selecting radio buttons, or by selecting from drop-down menus). The lead record is preferably formatted according to a predefined layout (e.g., XML, delimited, or fixed-length) agreed upon by Company A and Company B.

Preferably, the lead record is transmitted via a computer network, such as the Internet, from Company A to Company B. This improves the efficiency of the process by providing Company B with the information gathered by Company A verbatim without requiring Company B to independently collect the information in the lead record from the customer. The process of capturing the lead record from the first representative at Company A is preferably implemented as a web service located at a defined location, such as a server name or URL, which will typically be a Company B server configured for Business-to-Business (B2B) communication. Any suitable communication and transmission protocols, including, without limitation, Microsoft Simple Object Access Protocol (SOAP), are within the spirit and scope of the present invention. The service is preferably managed using Microsoft's Internet Information Server (IIS) software, but could also be managed using Java, IBM's WebSphere, Apache, or another suitable software program. Further, the connection to Company B's B2B server is preferably secure, and may be implemented using secure http protocols (https://) or by establishing a virtual private network (VPN) between Company A and Company B.

The first representative may be authenticated to the web service via an authentication routine, for example an authentication routine that verifies a username and password combination submitted by the first representative. Once the Company B web service has authenticated the first representative, the lead record may be transmitted from Company A to Company B. It should be understood that, based upon the authentication information submitted by the first representative, the system may associate the lead record with the business partner from whom it originated (e.g., Company A).

Once received by Company B, the lead record may be validated in step 160, for example to ensure that it conforms to the agreed-upon format. If the lead record fails validation, an error message may be transmitted to Company A and/or to the first representative for appropriate corrective action. Upon successful validation of the lead record, the lead record may be stored by the web service to a lead record database belonging to Company B (step 170), and a confirmation message may be transmitted to Company A. The confirmation message may, but need not be, presented to the first representative.

The next stage of the process, illustrated in the flowchart of FIG. 2, involves creation of a sales record. In the insurance context, the sales record may be referred to as an “enrollment record,” since the customer will be enrolling in an insurance contract. A sales record in the process of generation (e.g., prior to actually completing the sale by collecting payment and billing information) may be referred to as a “pending sales record,” or, in the case of insurance sales, a “pending enrollment record.”

In step 200, a communication session is established between the customer and the second representative. Preferably, the communication session between the customer and the second representative is established without first terminating the communication session between the customer and the first representative. For example, if the communication session is telephonic, the first representative may transfer the customer to the second representative or establish a conference between the first representative, the second representative, and the customer. It is within the scope of the invention, however, for the communication session between the customer and the first representative to be terminated and a new communication session established between the customer and the second representative. For example, if the customer calls Company A at a time when Company B is closed, or if the customer lacks the time to talk to the second representative but is interested in purchasing a product, the second representative may call the customer back at a later time. Information regarding a convenient time for the second representative to call the customer back may be input to the lead record by the first representative prior to transmitting the lead record to Company B. Alternatively, the information may be input to the pending sales record by the second representative if the customer elects to terminate the communication session with the second representative for whatever reason.

In step 210, the second representative accesses the lead record database and retrieves the lead record for the customer that was stored in step 170. The second representative may be authenticated to the lead record database via an authentication routine, such as an authentication routine that verifies a username and password combination. Preferably, the second representative accesses the lead record database through the Internet via a web browser such as Microsoft Internet Explorer. It should be understood that, rather than transferring the lead record from Company A to Company B via a computer network, the first and second representatives may access the same database (e.g., via an intranet, extranet, or the Internet).

Once the second representative has retrieved the lead record and is communicating with the customer, the second representative may complete the sales record for the customer in step 220. The sales record preferably includes at least some of the information that was transmitted in the lead record, such that the second representative need not repeat questions that the first representative asked of the customer. Thus, the sales record may be pre-populated with information from the lead record. Of course, the sales record may also be augmented with additional information as desired or required, for example through a series of question prompts presented to the second representative and asked of the customer. It may also be desirable for the second representative to verify the pre-populated information with the customer (e.g., verify that the name from the lead record matches the customer's name). As with the lead record, information is preferably input to the sales record via a web-based form.

Based at least in part upon the sales record, a menu of Company B products from which the customer may select is generated in step 230. The process of generating the menu typically begins with a large list of available products (e.g., all products offered by Company B) and narrows that list based on different criteria, such as state regulatory requirements, marketing requirements, and information within the sales record (e.g., the customer's age, gender, and state of residence).

In step 230a, a database of products, which preferably includes a plurality of Company B products, is accessed by the system. In step 230b, the sales record is used to identify one or more products within the database of products for which the customer is eligible. Typically, the customer will be eligible for between about two products and about four products, which are compiled into the menu in step 230c and presented to the second representative in step 230d. It should be understood that the menu may be identical to those Company B products offered by Company A. Alternatively, the menu may include products in addition to those offered by Company A (that is, Company B may offer the customer products other than those offered through its business partner, Company A, and may also include products offered by a Company C to customers of Company B). Optionally, the menu further includes pricing information for the products that the customer may select from.

In step 240, the customer selects a product from the menu of products (e.g., a $25,000 term life insurance policy), and the sales record is updated with information concerning the selected product. In some embodiments of the invention, additional information may be required and collected based upon the selected product. This additional information may be determined and collected dynamically. The term “dynamically” refers to a process whereby certain selected products and/or certain answers to required items of information cause other items of information to become required, and so on. For example, if the customer selects a substantial life insurance policy, additional information may be required to complete an underwriting process. One example of information that may be required during an underwriting process is the customer's military status (e.g., active, reserve, retired, none). If the customer indicates that the customer is active duty military, the customer's status as a flyer may become required. As another example, the customer's status as a smoker may be required (e.g., smoker, non-smoker, former smoker). If the customer indicates that the customer is a smoker, the number of years the customer has smoked may become required. As yet another example, if the customer selects a Medicare supplemental product, and the system determines that the customer is not within an “open enrollment” period, it may be necessary to collect additional information to determine the customer's eligibility for the selected product based on state-specific requirements. Preferably, the system utilizes one or more suitably populated rule tables and/or information-gathering algorithms to dynamically determine and collect any required information.

Once all required information is collected, the sale of the product to the customer may be completed in step 250. The sale is typically completed by capturing payment and billing information from the customer, which may include capture of an electronic signature or otherwise recording and memorializing the customer's billing and payment instructions. These instructions are preferably associated with the sales record.

In insurance sales, only certain representatives (known as “agents”) are authorized or licensed by a particular state to sell certain products to customers within that state. Thus, the selected product and the customer's state of residence may be considered in identifying a representative authorized to sell the product to the customer. To complete the sale, therefore, a communication session is established between the customer and a representative authorized to sell the selected product in the state in which the customer resides.

Preferably, the authority level of a representative is validated in real-time during the authentication routine executed when the representative accesses the lead record or a pending sales record. This may be accomplished, for example, by looking up, in a licensure database, the representative's credentials at log in, and then providing the representative access and privileges only to the extent that the representative is licensed. For example, if the representative is only licensed in Virginia, then the system will grant the representative the ability to sell products only in Virginia. Similarly, if the representative is only licensed to sell life insurance, then the system will grant the representative only the ability to sell life insurance.

Of course, it is desirable to periodically update the licensure database to ensure that it reflects current licensing information for the representatives. Preferably, the licensure database is a single database, though multiple databases may be employed without departing from the spirit and scope of the present invention.

If the second representative is, in fact, authorized to sell the selected product to the customer, as verified when the second representative logs on to the system, there is no need to transfer the customer to or establish a conference with another (e.g., a third) representative that is authorized to sell the selected product in the customer's state of residence. If the involvement of an additional, authorized representative is required, the transition from the second representative to the third representative will generally be analogous to the transition from the first representative to the second representative. That is, the second representative may store the pending sales record to a database of pending sales records, where the third representative may retrieve it after being authenticated to the database of pending sales records via a suitable authentication routine, preferably including a verification of the third representative's licensing credentials.

Upon collecting all information required to complete the sales record, the representative authorized to sell the product to the customer submits the completed sales record, through an automated process, into the issuing and fulfillment system in step 260. The issuing and fulfillment system validates and approves the completed sales record and creates a new contract for the customer in step 270.

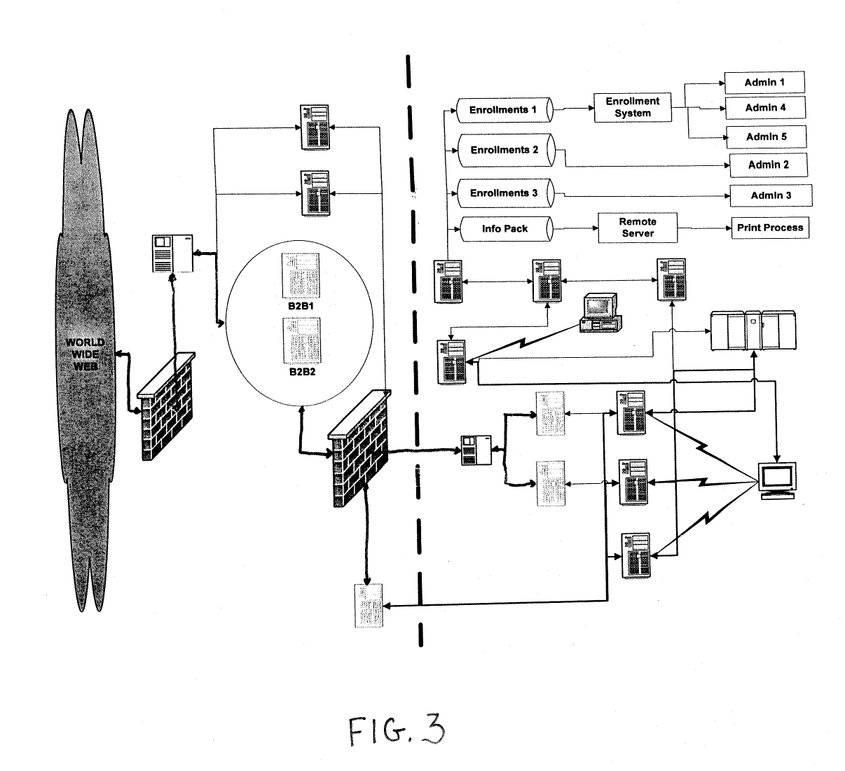

An example of the system and method according to an embodiment of the present invention will now be described with reference to FIGS. 3-11. FIG. 3 is a block diagram of an exemplary system according to an embodiment of the present invention. For purposes of FIG. 3, “SQL01” is the server that houses the SQLServer database that contains the information necessary to complete a transaction. “B2B1” and “B2B2” are the B2B servers that house the web service used by the outside company (e.g., Company A) to send information, such as lead records, to the seller (e.g., Company B). The B2B servers also preferably house the web pages and web forms utilized in the present invention. Content servers “CNT1” and “CNT2” are typically used for support processes, while “SERVER1” typically runs a batch job that sends enrollment records to the issuing and fulfillment system.

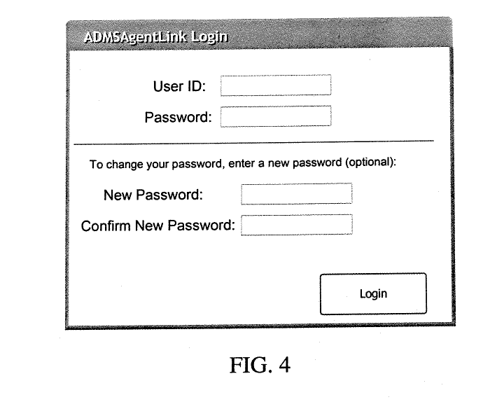

FIG. 4 illustrates an exemplary log-on screen that is presented to representatives attempting to access the system. Using this form, the representative enters a username and password combination, and a database of registered users is accessed to authenticate the representative to the system. Preferably, the authentication routine also determines the representative's authority level (e.g., the products, if any, the representative is licensed to sell, and where the representative is licensed to sell those products). As described above, the representative information may be maintained in one or more databases.

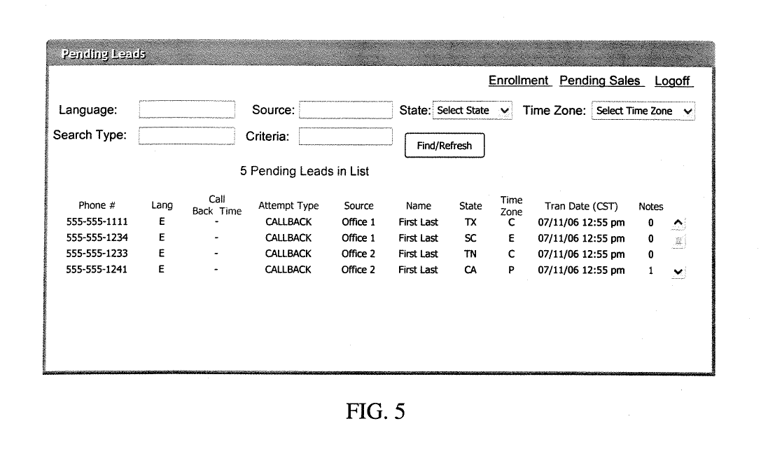

FIG. 5 depicts a plurality of lead records, including an identification of the business partner with whom the lead record originated (e.g., “AMQST”). Though the lead records are generated in real-time according to the process as described above, it is contemplated that they may be generated during non-business hours for Company B, in which case an agent may not be available to complete the sale. For example, Company A's call center may be a 24 hour call center, but Company B agents may be available only between 9 am and 5 pm Eastern time. Thus, the present invention contemplates accepting the lead record as a “CALLBACK” record, which is presented to the agent when the agent next accesses the lead record database (e.g., at the start of the next business day). Optionally, as described above, the lead record may include a time at which the customer has requested to be called back to complete the sale or request for information.

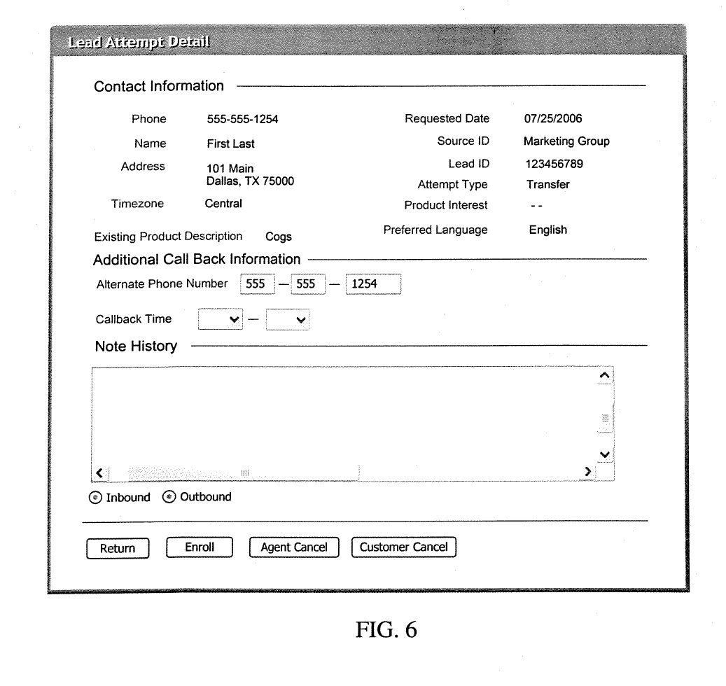

An exemplary individual lead record is shown in FIG. 6. The lead record shown is a “TRANSFER” record, indicating that it pertains to a customer that was transferred from the first representative to the second representative as part of a single communication session according to a preferred embodiment of the invention.

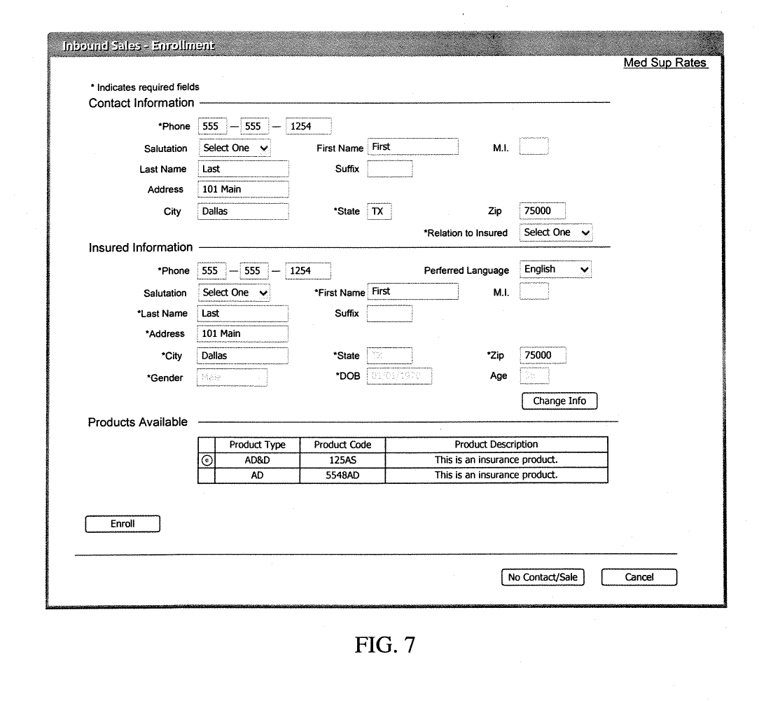

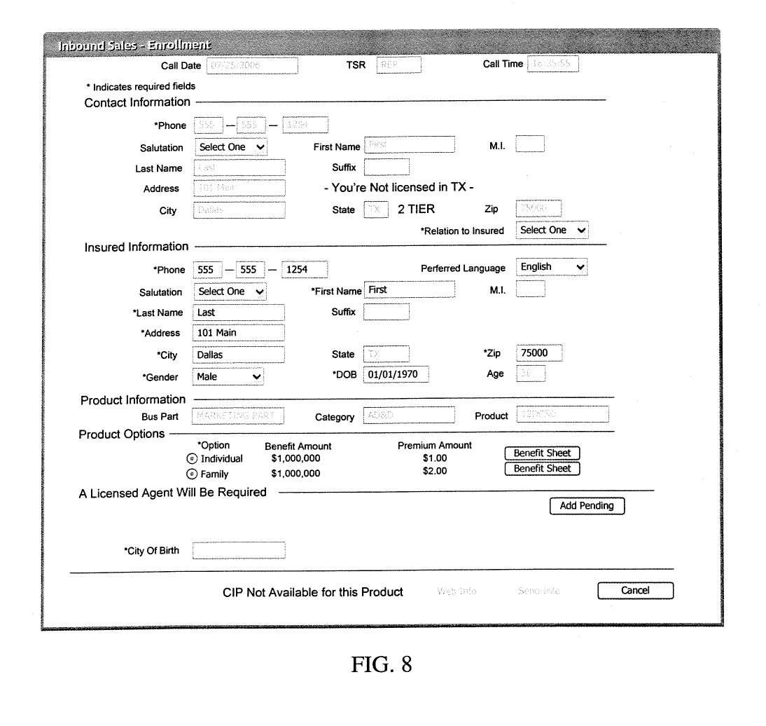

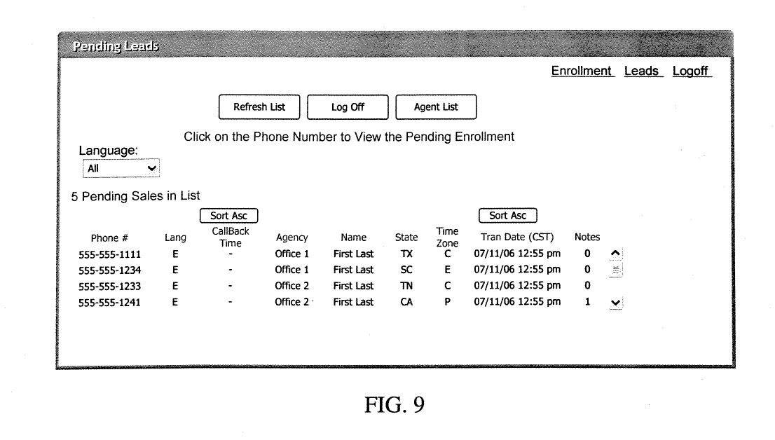

FIG. 7 is an exemplary sales record. Customer information has been filled in, via pre-population from the customer's lead record and/or supplementation as described above. The “Products Available” panel corresponds to the menu of products from which the customer can choose. In this case, the customer is eligible for only a single product. FIG. 8 illustrates the sales record after a product has been selected, whereupon the system has dynamically determined that the selected product includes two possible options: “Primary Individual” and “Family.” It should be noted that FIG. 8 depicts the screen as presented to a non-agent representative, and thus includes an “Add Pending” button to transfer the sales record to an agent, rather than an “Enroll” or “Submit” button, which would complete the sale. The sales record screen as presented to an agent is shown in FIG. 9.

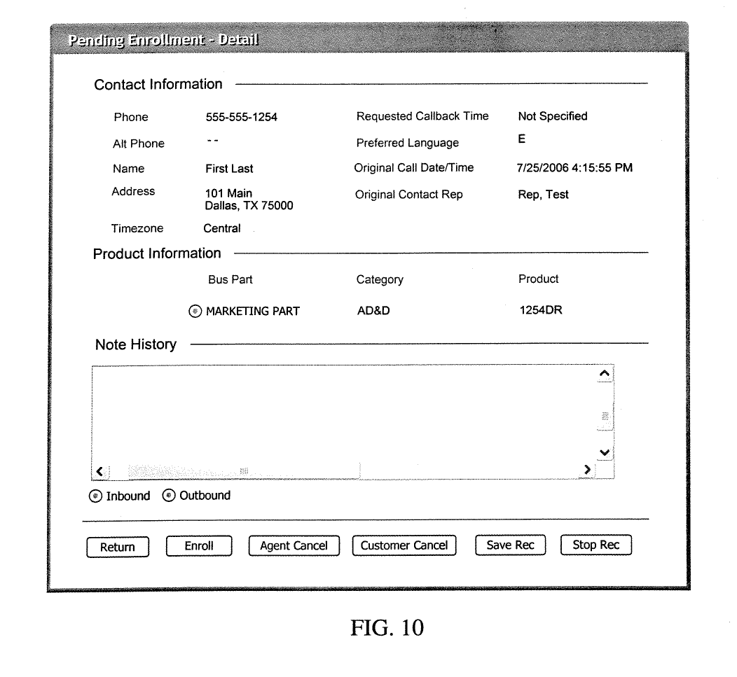

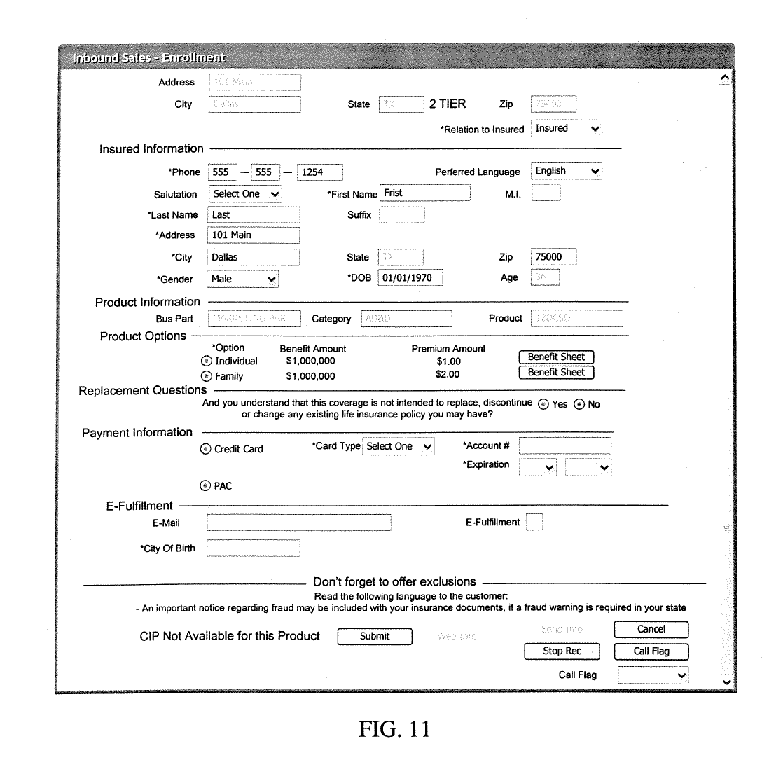

In the event that the second representative is not an agent, the customer may be transferred to an agent. The agent may, of course, retrieve the customer's enrollment record from an enrollment record database. Similarly, if the customer has called at a time when an agent is unavailable, the enrollment record may be stored and retrieved by the agent at a later time. FIG. 10 illustrates a plurality of enrollment records, analogous to the several lead records depicted in FIG. 5. An individual record retrieved from FIG. 10 is illustrated in FIG. 11.

By utilizing real-time feeds throughout the system, the present invention advantageously automatically processes customer segmentation, product eligibility, and product priority. Once a product of interest is selected, the present invention will display the relevant and necessary information for completing the sale/enrollment. This information may include, but is not limited to, needs analysis questions, related health questions for underwriting, rate and benefit information, regulatory and compliance language, state specific information, and all policy specific information such as exclusions and disclosures required by law.

The present invention is unique at least for the reason that a customer contacting the call center for a first company (e.g., Company A) can complete an enrollment over the phone with an authorized representative utilizing an electronic signature. The customer's data (e.g., the lead record) is passed from one company call center to the other via the system of the present invention without requiring the customer to repeat the information. Advantageously, the present invention is also capable of transferring the customer between representatives without disconnecting the customer from the system. The sale is thus completed in a reduced amount of time.

Another advantage of the present invention is that it permits non-insurance companies, such as Company A, the ability to determine eligibility for and offer to customers a highly-regulated product without taking on the burden of regulation, licensure, or employment of agents. By seamlessly transferring the customer to an agent, the present invention permits Company A to leverage Company B's agent's. Company B, in turn, receives the benefit of Company A's pre-screening of customers and lead record generation, which reduces the administrative burden of collecting information prior to completing the sale.

Where multiple databases are maintained (e.g., one or more Company A databases and one or more Company B databases), it is contemplated that a reconciliation process may be utilized to keep the databases synchronized. The databases may be reconciled on any schedule (e.g., monthly, weekly, daily, or every time a change is made), and are preferably reconciled on at least a daily basis. In some embodiments of the invention, the databases are converted to daily batch files and comparisons are made. In the event of a discrepancy, the entries may be flagged, or even removed to a temporary file, for detailed analysis.

The present invention also contemplates that the customer may initiate the process, for example through a web interface. That is, the customer may access the web interface via the Internet and enter the information into the web form that would otherwise be entered by one or more representatives. In effect, the customer can generate the customer's own lead record, including information regarding a preferred time for a follow-up call, and then may be contacted by an agent to complete the sale after submitting the lead record.

Similarly, the present invention contemplates that the customer may complete the process independent of the involvement of an agent. Since licensure is not required to complete an insurance sale over the Internet via a self-service website, the customer may generate the customer's own pending sales record according to a process generally analogous to that described herein.

It is also contemplated that the communication session need not be between the customer and a live representative; the communication session may also occur utilizing an integrated voice response system.

Although several embodiments of this invention have been described above with a certain degree of particularity, those skilled in the art could make numerous alterations to the disclosed embodiments without departing from the spirit or scope of this invention. For example, though the invention has been described with the first representative employed by Company A and the second representative employed by Company B, it should be understood that the second representative may also be employed by Company A, or even by a third Company C. Since the various representatives described herein may be employed by any number of companies, the present invention contemplates, without limitation, both internal lead generation (e.g., the first and second representatives are both employed by the same company) and external lead generation (e.g., the first representatives are employed by different companies).

In addition, though the invention has been described as implemented via an Internet-based computer network using web forms and web services, other computer networks are regarded as within the spirit and scope of the invention.

Further, though the invention has been described in connection with the sale of insurance products, one of ordinary skill in the art will recognize that it may be applied with equal success to the sale of other products.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. An automated process for providing sales services, comprising:
establishing a communication connection between a customer and a first representative using a switching network;
providing a plurality of prompts to the first representative who will then ask questions of the customer to obtain a first plurality of customer data sets;
storing the first plurality of customer data sets into a database, said first plurality of customer data sets including at least the following: identification information, residence information, and a desired product;
identifying a second representative based in part on the residence information and the desired product;
establishing a communication connection between at least the customer and the second representative without disconnecting the customer from the switching network;
providing a plurality of prompts to the second representative who will then ask questions of the customer to obtain a second plurality of customer data sets, wherein the second plurality of customer data sets include at least some information that is not included in the first plurality of data sets;
storing the second plurality of customer data sets into a database; and
completing a sale between the second representative and the customer before disconnecting the customer from the switching network.

2. The process of claim 1, further comprising granting a first representative access to the database based on a validation of user identification information and a password.

3. The process of claim 2, further comprising granting the second representative access to the customer based on a validation of user identification information, a password, and a verification that the second representative is licensed to sell the desired product within the state that the customer resides.

4. The process of claim 3, further comprising giving the second representative access to the first plurality of customer data sets.

5. The process of claim 2, further comprising:
accessing a database that contains licensing information for a plurality of representatives; and
granting the second representative access to the customer based on a validation of user identification information, a password, and a verification that the second representative is licensed to sell the desired product within the state that the customer resides.

6. The process of claim 1, further comprising granting the second representative access to the database based on a validation of user identification information and a password.

7. The process of claim 1, wherein the step of establishing a communication connection between at least the customer and the second representative comprises using a telephone system to transfer the customer from the first representative to the second representative.

8. The process of claim 1, wherein the step of establishing a communication connection between at least the customer and the second representative comprises using a telephone system to create a conference between the second representative, the customer, and the first representative.

9. The process of claim 1, further comprising giving the second representative access to the first plurality of customer data sets.

10. The process of claim 1, wherein the step of completing the sale comprises:
verifying that the customer is interested in purchasing the desired product;
providing the customer with pricing information for the desired product; and
obtaining payment instructions from the customer who is paying for the desired product.

11. The process of claim 1, wherein the step of completing the sale comprises:
verifying that the customer is interested in purchasing the desired product;
providing the customer with pricing information for the desired product; and
recording payment instructions from the customer who is paying for the desired product.

12. An automated process for providing sales services, comprising the steps of:
establishing a communication connection between a customer and a switching network;
presenting a first plurality of questions to the customer to obtain a first plurality of customer data sets, said first plurality of customer data sets including at least the following: identification information, state of residence, and a desired product;
storing the first plurality of customer data sets into a common database;
identifying a second representative based in part on the residence information and the desired product, said identifying process also including the step of verifying that the second representative is licensed to sell the desired product for the customer's state of residence;
establishing a communication connection between at least the customer and the second representative without disconnecting the customer from the switching network;
giving the second representative access to the first plurality of customer data sets;
presenting a second plurality of questions to the customer to obtain a second plurality of customer data sets, said second plurality of customer data sets including information not included in the first plurality of customer data sets;
storing the second plurality of customer data sets into the common database; and
completing a sale between the second representative and the customer before disconnecting the customer from the switching network.

13. The process of claim 12, wherein the step of establishing a communication connection between a customer and a switching network comprises:
establishing a connection between a customer and a switching network;
identifying a first representative who is available to communicate with the customer; and
establishing a communication connection between the customer and the first representative without disconnecting the customer from the switching network.

14. The process of claim 13, wherein the step of presenting a first plurality of questions to the customer comprises:
presenting a first plurality of prompts to the first representative who in turn asks a first plurality of questions of the customer to obtain a first plurality of customer responses; and
entering the plurality of customer responses to form a first plurality of customer data sets, said first plurality of customer data sets including at least the following: identification information, state of residence, and a desired product.

15. The process of claim 12, wherein the step of completing the sale comprises:
verifying that the customer is interested in purchasing the desired product;
providing the customer with pricing information for the desired product; and
obtaining payment instructions from the customer who is paying for the desired product.

16. The process of claim 12, wherein the step of completing the sale comprises:
verifying that the customer is interested in purchasing the desired product;
providing the customer with pricing information for the desired product; and
recording payment instructions from the customer who is paying for the desired product.

17. The process of claim 16, wherein the step of recording payment instructions comprises:
recording a conversation in which the customer authorizes payment; and
associating the record with a database entry.

18. The process of claim 16, wherein the step of recording payment instructions comprises capturing data indicative of the customer's authorization of a payment.

19. A system for assisting in the provision of services, comprising:
a switching network that supports communication connections;
a customer interface which accepts inquiries from a customer;
a first representative interface that permits a first registered user to access the switching network and to communicate with the customer;
a first input interface to permit the first registered user to input a first plurality of customer data sets including at least the following: identification information, state of residence, and a desired product;
a first database to store the first plurality of customer data sets;
a second representative interface that permits a second registered user to access the switching network and the database, and to communicate with the customer, wherein the interface permits access based on the residence information, the desired product, and a confirmation that the second registered user is licensed to sell the desired product for the customer's state of residence, and wherein the second representative interface establishes a communication connection between the customer and the second registered user without disconnecting the customer from the switching network;
a second input interface to permit the second registered user to input a second plurality of customer data sets, said second plurality of customer data sets including information not included in the first plurality of customer data sets; and
a second database to store the second plurality of customer data sets.

20. The system of claim 19, wherein the first database and the second database are common to each other.

21. The system of claim 19, further comprising a recorder to record confirmation information to acknowledge the customer has requested to purchase the desired product.

22. The system of claim 19, further comprising a transaction system to complete a sale of the desired product to the customer.

23. A system for assisting in the provision of services, comprising:
a switching network that supports communication connections;
a customer interface which accepts inquiries from a customer;
a first input menu to create a first plurality of customer data sets including at least the following: identification information, state of residence, and a desired product;
a database to store the first plurality of customer data sets; and
a representative interface that permits a registered user to access the database based on the residence information, the desired product, and a confirmation that the registered user is licensed to sell the desired product for the customer's state of residence, and wherein the representative interface permits the establishment of a communication connection between the customer and the registered user in real time such that the registered user may complete a sale.

24. The system of claim 23, further comprising a recording system to record confirmation information that the customer has authorized a purchase of the desired product.

25. The system of claim 23, further comprising a transaction system to complete a sale of the desired product to the customer.

26. The system of claim 23, wherein the representative interface permits the completion of a transaction within less than about fifteen minutes from a time at which the first plurality of customer data sets was input.

27. An automated process for providing sales services, comprising the steps of:
establishing a communication connection between a customer and a first representative using a switching network;
providing a plurality of prompts to the first representative who will then ask questions of the customer to obtain a first plurality of customer data sets;
storing the first plurality of customer data sets into a first database, said first plurality of customer data sets including at least the following: identification information, residence information, and a desired product;
automatically identifying a second representative in response to the residence information and the desired product;
automatically establishing a communication connection between at least the customer and the second representative without disconnecting the customer from the switching network;
providing a plurality of prompts to the second representative who will then ask questions of the customer to obtain a second plurality of customer data sets, wherein the second plurality of customer data sets include at least some information that is not included in the first plurality of data sets; and
storing the second plurality of customer data sets into a second database.

28. An automated process for providing sales services, comprising:
establishing a communication session between a customer and a first representative;
alerting the first representative to at least one product for which the customer is eligible;
transmitting at least identification data regarding the customer to a second representative upon determining that the customer is interested in purchasing the at least one product for which the customer is eligible;
establishing a communication session between the customer and the second representative;
completing a sales record for the customer, the sales record including at least the identification data transmitted to the second representative;
generating a menu of products from which the customer may select based at least in part upon the sales record;
selecting a product from the menu of products; and
completing a sale of the selected product.

29. The process of claim 28, further comprising:
identifying one or more products to be offered; and
segmenting a customer database to match the one or more offered products with customers within the customer database who are eligible for the one or more offered products,
wherein the step of alerting the first representative to at least one product for which the customer is eligible alerts the first representative based upon information in the segmented customer database.

30. The process of claim 28, wherein the step of completing a sales record for the customer comprises:
pre-populating the sales record with at least the identification data regarding the customer transmitted to the second representative; and
augmenting the sales record with at least one additional item of data regarding the customer gathered by the second representative.

31. The process of claim 30, wherein the at least one additional item of data includes a state of residence of the customer.

32. The process of claim 30, further comprising verifying the pre-populated sales record with the customer.

33. The process of claim 28, wherein the step of generating a menu of products from which the customer may select based at least in part upon the sales record comprises:
accessing a database of products;
identifying, based at least in part upon the sales record, one or more products within the database for which the customer is eligible; and
compiling the identified one or more products within the database for which the customer is eligible into a menu of products.

34. The process of claim 28, wherein the step of completing a sale of the selected product comprises:
establishing a communication session between the customer and a representative authorized to sell the selected product to the customer;
providing the representative authorized to sell the selected product with the sales record for the customer and information concerning the selected product; and
having the authorized representative complete the sale of the selected product.

35. The process of claim 34, wherein the step of providing the representative authorized to sell the selected product with the record for the customer and information concerning the selected product comprises:
storing the sales record to a database of pending sales records, wherein the sales record includes the information concerning the selected product;
granting the representative authorized to sell the selected product access to the database of pending sales records; and
presenting the sales record to the representative authorized to sell the selected product.

36. The process of claim 34, wherein the representative authorized to sell the selected product is neither the first representative nor the second representative.

37. The process of claim 34, further comprising analyzing one or more of the selected product and a state of residence of the customer to assist in identifying the representative authorized to sell the selected product.

38. The process of claim 28, wherein the step of transmitting at least identification data regarding the customer to a second representative comprises:
generating a lead record including at least identification data regarding the customer;
storing the lead record to a database of lead records;
granting the second representative access to the database of lead records; and
presenting the lead record to the second representative.

39. The process of claim 28, wherein the step of establishing a communication session between the customer and the second representative comprises initiating a communication session between the customer and the second representative without terminating the communication session between the customer and the first representative.

40. The process of claim 39, wherein the step of initiating a communication session between the customer and the second representative comprises using a communication network to transfer the customer to the second representative.

41. The process of claim 40, wherein the communication network is a telephone network.

42. The process of claim 28, further comprising, after the step of selecting a product from the menu of products:
determining, based upon the selected product, one or more items of additionally required customer information; and
collecting the determined one or more items of additionally required customer information.

43. The process of claim 42, wherein the one or more items of required information are determined and collected dynamically.

44. An automated process for product sales, comprising:
establishing a communication session between a customer and a computer system, wherein the computer system is provided with access to a database of products that may be offered for sale to the customer;
collecting a plurality of data from the customer, the plurality of data including at least data identifying the customer and a state of residence of the customer;
identifying at least one product within the database of products for which the customer is eligible based, at least in part, upon the state of residence of the customer;
selecting one of the identified products for purchase;
establishing a communication session between the customer and a representative authorized to sell the selected product; and
having the representative authorized to sell the selected product complete a sale of the selected product.

45. The process of claim 44, wherein the communication session between the customer and the computer system is mediated by at least one representative.

46. The process according to claim 45, wherein the customer and the representative are connected over a telephone network.

47. The process of claim 44, wherein the communication session between the customer and the computer system occurs through an integrated voice response system.

48. The process of claim 44, wherein the step of collecting a plurality of data from the customer comprises entering the plurality of data via a web-based user interface.

49. An automated process for generating sales leads, comprising:
selecting one or more products provided by a first company to be offered to customers of a second company;
updating customer records within a customer database of the second company to include information regarding those of the selected one or more products for which each customer is eligible;
notifying a customer of the second company that the customer is eligible for a product provided by the first company;
ascertaining the customer's level of interest in the product provided by the first company for which the customer is eligible; and
creating a lead record including at least information identifying the customer, the product for which the customer is eligible, and the customer's level of interest in the product.

50. The process of claim 49, further comprising transmitting the lead record to the first company.

51. The process of claim 49, further comprising:
establishing a real-time communication session between the customer and the second company; and
notifying the customer that the customer is eligible for a product provided by the first company during the real-time communication session.

52. The process of claim 51, wherein the real-time communication session is established between the customer and a representative of the second company.

53. An automated sales system, comprising:
a communication network;
a customer database;
a first representative interface that permits a first registered user to access the communication network and the customer database;
a notification processor to retrieve from the customer database a customer record for a customer connected to the communication network, wherein the customer record includes identification information for the customer and information regarding one or more products for which the customer is eligible, and wherein the notification processor generates a notification to the first representative that the customer is eligible for one or more products;
a lead record database to store a plurality of lead records; and
a lead processor to generate a lead record and store the lead record to the lead record database, wherein the lead record is generated when the customer connected to the communication network indicates interest in one or more products for which the customer is eligible, and wherein the lead record includes at least the identification information for the customer.
